(19) United States
(12) Patent Application Publication
(10) Pub. No.: US 2018/0156099 A1
(43) Pub. Date: Jun. 7, 2018

(54) METHOD OF MEASURING AN EXHAUST GAS TEMPERATURE

(71) Applicant: GM GLOBAL TECHNOLOGY OPERATIONS LLC, Detroit, MI (US)

(72) Inventors: Andrea DUTTO, Torino (IT); Giorgio STICCHI, Maglie (IT); Michele ROSMARINO, Mainz (DE)

(73) Assignee: GM GLOBAL TECHNOLOGY OPERATIONS LLC, Detroit, MI (US)

(21) Appl. No.: 15/370,252

(22) Filed: Dec. 6, 2016

(51) Int. Cl. F01N 11/00; F01N 3/20; B01D 53/94

(52) U.S. Cl. CPC F01N 11/005; F01N 3/2066; F01N 3/206; F01N 3/2033; F01N 2610/148; B01D 53/944; F01N 2610/02; F01N 2610/03; F01N 2610/1453; B01D 53/9431

(57) ABSTRACT

A method of measuring exhaust gas temperatures in an exhaust pipe of an internal combustion engine is disclosed. A value of a mass flow rate of exhaust gasses flowing into the exhaust pipe is determined. A signal yielded by a temperature sensor located in a first point of the exhaust pipe is sampled and applied as input to a first computational module that yields a corresponding first output signal. A value of the temperature of the exhaust gasses flowing in the first point of the exhaust pipe is calculated on the basis of a value of the first output signal.

### TECHNICAL FIELD

The present disclosure pertains to a method of measuring a temperature of the exhaust gasses that flow along an exhaust pipe of an internal combustion engine, typically an internal combustion engine of a motor vehicle, such as for example a Diesel engine or a gasoline engine.

### BACKGROUND

It is known that an internal combustion engine is provided with an exhaust system having an exhaust pipe and one or more aftertreatment devices, such as for example oxidation catalysts, lean NOₓ traps and selective catalytic reduction (SCR) systems, which are located in the exhaust pipe to change the composition of the exhaust gasses with the aim or reducing polluting emissions.

In order to maintain proper functioning of the internal combustion engine, the exhaust system and particularly the aftertreatment devices, it is generally necessary to take into account the temperature of the exhaust gasses in different points of the exhaust pipe, in particular upstream and/or downstream of such aftertreatment devices.

Typically these temperatures are either measured by dedicated sensors which are directly located in the prescribed point of the exhaust pipe, or estimated on the basis of measurements made by temperature sensors located in different points of the exhaust pipe.

However, the values measured by the temperature sensors are always affected by the so-called “response delay” of the sensor, which is the time necessary for the sensor to change its output in response of a change in the real temperature of the exhaust gasses, so that, during transients, the temperature sensors usually outputs temperature values which are “delayed” with respect to the actual exhaust gas temperatures.

### SUMMARY

In accordance with the present disclosure, a method of measuring an exhaust gas temperature is provided that solves or at least positively reducing the above mentioned delay effect. In an embodiment according to the present disclosure, a method is provided for measuring exhaust gas temperatures in an exhaust pipe of an internal combustion engine. A value of a mass flow rate of exhaust gasses flowing into the exhaust pipe is determined. A signal yielded by a temperature sensor located in a first point of the exhaust pipe is sampled and applied as input to a first computational module that yields a corresponding first output signal. The first computational module has the following transfer function (in frequency domain):

F*(s)=(1+τ_{RT}·s)·F(s)

wherein F(s) is the signal yielded by the temperature sensor, F*(s) is the first output signal and τ_{RT} is a coefficient determined as a function of the measured value of the mass flow rate of exhaust gasses. A value of the temperature of the exhaust gasses flowing in the first point of the exhaust pipe is calculated on the basis of a value of the first output signal.

This solution is based on the observation that, with respect to a change of the real temperature of the exhaust gasses, a temperature sensor generally behaves as a first order dynamic system having a characteristic time constant τ_{RT} which, in its turn, depends on the mass flow rate of the exhaust gasses that hit the sensor. In view of that, the present solution applies the signal generated by the temperature sensor to a first computational module whose transfer function is substantially the inverse of the transfer function of the sensor itself, so that the output of such computational module represents a reliable prediction of the real exhaust gas temperature without delay.

According to an aspect of the method, the first computational module may implement the following equation (in time domain):

f*(t)=f(t)+τ_{RT}·f′(t)

wherein f(t) is a value of the signal sampled at a time t, f*(t) is a value of the first output signal at the time t, and f′(t) is a value of a derivative of the signal at the time t. This aspect provides an effective solution for allowing the first computational module to respond according to the required transfer function, while processing the sensor signal in time domain.

According to another aspect, the method may include the step of calculating the value f′(t) of the derivative of the signal with a finite difference equation. The use of a difference equation allows a reliable approximation of the derivative of the signal. In particular, the calculation of the value f′(t) of the derivative of the signal may be performed with the following finite difference equation:

$${f}^{′} ( t ) = \frac{1}{T} \cdot {\sum }_{k = 0}^{n} {C}_{k} \cdot f ( t - kT )$$

wherein T is a sampling period of the signal, f(t−kT) is a value of the signal sampled at the time t−kT, Cₖ is a predetermine coefficient and n is a predetermined positive real number. This difference equation is the equation of a “backward finite difference” which has the effect of providing reliable results with a limited computational effort.

By way of example, the sampling period T may be equal to 0.1 seconds, the number n may be equal to 3, the coefficient C₀ may be equal to 11/6, the coefficient C₁ may be equal to 3, the coefficient C₂ may be equal to 3/2 and the coefficient C₃ may be equal to ⅓. In this way, the “backward finite difference equation” has a 3rd order accuracy (n=3), thereby guaranteeing an efficient computational structure and noise suppression.

According to a different aspect, the method may include applying the first output signal to a second computational module that yields a corresponding second output signal, wherein the second computational module has the following transfer function (in frequency domain):

$${{F}^{*}}^{*} ( s ) = \frac{1}{1 + {τ}_{TC} \cdot s} \cdot {F}^{*} ( s )$$

wherein F**(s) is the second output signal and τ_{TC} is a coefficient determined as a function of the measured value of the mass flow rate of exhaust gasses. The value of the temperature of the exhaust gasses flowing in the first point of the exhaust pipe is then calculated on the basis of a value of the second output signal.

As a matter of fact, the second computational module is a first-order filter with time constant τ_{TC}. This filter is useful for preventing too fast responses during transients and thus for reducing noises of the first output signal.

According to an aspect of the method, the second computational module may implement the following equation (in time domain):

$${{f}^{*}}^{*} ( t ) = K \cdot ( 1 - {e}^{\frac{- t}{{τ}_{TC}}} ) \cdot {f}^{*} ( t )$$

wherein f*(t) is a value of the first output signal at a time t, f**(t) is a value of the second output signal at the time t and K is a coefficient. This aspect provides an effective solution for allowing the second computational module to respond according to the required transfer function, while processing the signal in time domain.

According to another aspect of the method, the second computational module may implement the following equation:

f**(t)=f*(t)·K_{TC}+f**(t−T)·(1−K_{TC})

wherein f*(t) is a value of the first output signal at a time t, f**(t) is a value of the second output signal at the time t, K_{TC} is a coefficient determined as a function of the measured value of the flow rate of exhaust gasses, and T is a sampling period of the signal. This particular solution has the effect of providing reliable results with a limited computational effort.

According to a different aspect, the method may include estimating a value of a temperature of the exhaust gasses flowing in a second different point of the exhaust pipe on the basis of the calculated value of the temperature of the exhaust gasses in the first point. Taking advantage of the accelerated response of the temperature sensor located in the first point of the exhaust pipe, this aspect of the method allows a reliable and efficient estimation of the exhaust gas temperature also in another point of the exhaust pipe, without the need of additional temperature sensors.

In particular, the value of the temperature of the exhaust gasses flowing in the second point of the exhaust pipe may be calculated with the following equation:

$${T}_{1} \cdot {\dot{m}}_{g} \cdot {c}_{{p}_{g}} + {T}_{u} \cdot {\dot{m}}_{u} \cdot {c}_{{p}_{u}} + {T}_{2} \cdot ( {\dot{m}}_{g} \cdot {c}_{{p}_{g}} + {\dot{m}}_{u} \cdot {c}_{{p}_{u}} ) - ( {m}_{u} + {m}_{g} ) \cdot {c}_{{p}_{m}} \cdot \frac{{dT}_{m}}{dt} - {\dot{Q}}_{mw} - {\dot{m}}_{u} \cdot {k}_{vap} = 0$$

wherein T₁ is a value of the temperature of the exhaust gasses flowing in a first point of the exhaust pipe, \dot{m}_{g} is the value of a mass flow rate of exhaust gasses flowing in the exhaust pipe, cₚ_{_{g}} is a specific heat capacity of the exhaust gasses, Tᵤ is a temperature value of a fluid injected by an injector located between the first and the second point of the exhaust pipe, \dot{m}ᵤ is a value of a mass flow rate of the injected fluid, cₚ_{ᵤ} is a specific heat capacity of the injected fluid, T₂ is the value of the temperature of the exhaust gasses flowing in the second point of the exhaust pipe, mᵤ is a value of a mass of the injected fluid in the exhaust pipe, m_{g} is a value of a mass of exhaust gasses in the exhaust pipe, cₚ_{ₘ} is a specific heat capacity of a mixture of exhaust gasses and injected fluid in the exhaust pipe, is a mean value of the temperature of the mixture of exhaust gasses and injected fluid, \dot{Q}_{mw} is a value of a thermal flux between the exhaust pipe and the mixture of exhaust gasses and injected fluid, and kᵥₐₚ is a coefficient representative of an energy spent for mixing and vaporizing the injected fluid.

This solution is useful to estimate the temperature of the exhaust gasses in any application that involves a fluid injector located between the first point and the second point of the exhaust pipe. Indeed, the last-mentioned aspect of the method provides an effective thermal model of the portion of the exhaust pipe where the fluid injector is located, which takes into account all the major thermal effects that happen in such portion of the exhaust pipe, including the energy consumed to mix and vaporize the injected fluid within the exhaust gasses (by the term −\dot{m}ᵤ·kᵥₐₚ of the above-indicated equation), thereby yielding a reliable estimation of the exhaust gas temperature along such portion of the exhaust pipe.

The fluid injector may be for example a hydrocarbon (HC) injector located upstream of an oxidization catalyst or a diesel exhaust fluid (DEF) injector located upstream of a selective catalytic reduction (SCR) brick. The SCR brick is an aftertreatment device designed for promoting the conversion of nitrogen oxides (NOₓ) into diatomic nitrogen and water. To perform this function, a DEF injector is generally located in the exhaust pipe, upstream of the SCR brick, in order to inject a Diesel Exhausts Fluid (DEF), typically urea or ammonia, into the stream of exhaust gasses. The DEF vaporizes, mixes with the exhaust gasses and is adsorbed into the SCR brick to serve as a reducing agent. To improve the mixing of the DEF in the exhaust gasses, a mixer may be located in the exhaust pipe between the DEF injector and the inlet of the SCR brick.

According to the present disclosure, the method can be carried out with the help of a computer program including a program-code for carrying out all the steps of the method described above, and in the form of a computer program product including the computer program. The method can be also embodied as an electromagnetic signal, the signal being modulated to carry a sequence of data bits which represent a computer program to carry out all steps of the method.

Another embodiment of the present disclosure provides an internal combustion engine including an exhaust pipe and an electronic control unit configured to determine a value of a mass flow rate of exhaust gasses flowing into the exhaust pipe, sample a signal yielded by a temperature sensor located in a first point of the exhaust pipe, and apply the signal as input to a first computational module that yields a corresponding first output signal, wherein the first computational module has the following transfer function (in frequency domain):

F*(s)=(1+τ_{RT}·s)·F(s)

wherein F(s) is the signal yielded by the temperature sensor, F*(s) is the first output signal and τ_{RT} is a coefficient determined as a function of the measured value of the mass flow rate of exhaust gasses. A value of the temperature of the exhaust gasses flowing in the first point of the exhaust pipe is calculated on the basis of a value of the first output signal. This solution achieves essentially the same effects of the method described above, in particular that of providing a reliable prediction of the real exhaust gas temperature without delay.

According to an aspect of the internal combustion engine, the first computational module may be configured to implement the following equation (in time domain):

f*(t)=f(t)+τ_{RT}·f′(t)

wherein f(t) is a value of the signal sampled at a time t, f*(t) is a value of the first output signal at the time t, and f′(t) is a value of a derivative of the signal at the time t. This aspect provides an effective solution for allowing the first computational module to respond according to the required transfer function, while processing the sensor signal in time domain.

According to another aspect, the electronic control unit may be configured to calculate the value f′(t) of the derivative of the signal with a finite difference equation. The use of a difference equation allows a reliable approximation of the derivative of the signal.

In particular, the electronic control unit may be configured to calculate of the value f′(t) of the derivative of the signal with the following finite difference equation:

$${f}^{′} ( t ) = \frac{1}{T} \cdot {\sum }_{k = 0}^{n} {C}_{k} \cdot f ( t - kT )$$

wherein T is a sampling period of the signal, f (t−kT) is a value of the signal sampled at the time t−kT, Cₖ is a predetermine coefficient and n is a predetermined positive real number. This difference equation is the equation of a “backward finite difference” which has the effect of providing reliable results with a limited computational effort.

By way of example, the sampling period T may be equal to 0.1 seconds, the number n may be equal to 3, the coefficient C₀ may be equal to 11/6, the coefficient C₁ may be equal to 3, the coefficient C₂ may be equal to 3/2 and the coefficient C₃ may be equal to ⅓. In this way, the “backward finite difference equation” has a 3rd order accuracy (n=3), thereby guaranteeing an efficient computational structure and noise suppression.

According to a different aspect of the internal combustion engine, the electronic control unit may be configured to apply the first output signal to a second computational module that yields a corresponding second output signal, wherein the second computational module has the following transfer function (in frequency domain):

$${{F}^{*}}^{*} ( s ) = \frac{1}{1 + {τ}_{TC} \cdot s} \cdot {F}^{*} ( s )$$

wherein F**(s) is the second output signal and T_{TC} is a coefficient determined as a function of the measured value of the mass flow rate of exhaust gasses. The value of the temperature of the exhaust gasses flowing in the first point of the exhaust pipe is calculated on the basis of a value of the second output signal. As a matter of fact, the second computational module is a first-order filter with time constant T_{TC}. This filter is useful for preventing too fast responses during transients and thus for reducing noises of the first output signal.

According to an aspect of the internal combustion engine, the second computational module may be configured to implement the following equation (in time domain):

$${{f}^{*}}^{*} ( t ) = K \cdot ( 1 - {e}^{\frac{- t}{{τ}_{TC}}} ) \cdot {f}^{*} ( t )$$

wherein f*(t) is a value of the first output signal at a time t, f**(t) is a value of the second output signal at the time t and K is a coefficient. This aspect provides an effective solution for allowing the second computational module to respond according to the required transfer function, while processing the signal in time domain.

According to another aspect of the internal combustion engine, the second computational module may be configured to implement the following equation:

f**(t)=f*(t)·K_{TC}+f**(t−T)·(1−K_{TC})

wherein f*(t) is a value of the first output signal at a time t, f**(t) is a value of the second output signal at the time t, K_{TC} is a coefficient determined as a function of the measured value of the flow rate of exhaust gasses, and T is a sampling period of the signal. This particular solution has the effect of providing reliable results with a limited computational effort.

According to a different aspect, the electronic control unit may be configured to estimate a value of a temperature of the exhaust gasses flowing in a second different point of the exhaust pipe on the basis of the calculated value of the temperature of the exhaust gasses in the first point. Taking advantage of the accelerated response of the temperature sensor located in the first point of the exhaust pipe, this aspect allows a reliable and efficient estimation of the exhaust gas temperature also in another point of the exhaust pipe, without the need of additional temperature sensors.

In particular, the electronic control unit may be configured to calculate the value of the temperature of the exhaust gasses flowing in the second point of the exhaust pipe with the following equation:

$${T}_{1} \cdot {\dot{m}}_{g} \cdot {c}_{{p}_{g}} + {T}_{u} \cdot {\dot{m}}_{u} \cdot {c}_{{p}_{u}} + {T}_{2} \cdot ( {\dot{m}}_{g} \cdot {c}_{{p}_{g}} + {\dot{m}}_{u} \cdot {c}_{{p}_{u}} ) - ( {m}_{u} + {m}_{g} ) \cdot {c}_{{p}_{m}} \cdot \frac{{dT}_{m}}{dt} - {\dot{Q}}_{mw} - {\dot{m}}_{u} \cdot {k}_{vap} = 0$$

wherein T₁ is a value of the temperature of the exhaust gasses flowing in a first point of the exhaust pipe, \dot{m}_{g} is the value of a mass flow rate of exhaust gasses flowing in the exhaust pipe, cₚ_{_{g}} is a specific heat capacity of the exhaust gasses, Tᵤ is a temperature value of a fluid injected by an injector located between the first and the second point of the exhaust pipe, \dot{m}ᵤ is a value of a mass flow rate of the injected fluid, cₚ_{ᵤ} is a specific heat capacity of the injected fluid, T₂ is the value of the temperature of the exhaust gasses flowing in the second point of the exhaust pipe, mᵤ is a value of a mass of the injected fluid in the exhaust pipe, m_{g} is a value of a mass of exhaust gasses in the exhaust pipe, cₚ_{ₘ} is a specific heat capacity of a mixture of exhaust gasses and injected fluid in the exhaust pipe, Tₘ is a mean value of the temperature of the mixture of exhaust gasses and injected fluid, \dot{Q}_{mw} is a value of a thermal flux between the exhaust pipe and the mixture of exhaust gasses and injected fluid, and kᵥₐₚ is a coefficient representative of an energy spent for mixing and vaporizing the injected fluid. This aspect provides an effective thermal model of the portion of the exhaust pipe upstream around the fluid injector, which takes into account all the major thermal effects that happen in such portion of the exhaust pipe, including the energy consumed to mix and vaporize the injected fluid within the exhaust gasses (by the term −\dot{m}ᵤ·kᵥₐₚ of the above-indicated equation), thereby yielding a reliable estimation of the exhaust gas temperature along such portion of the exhaust pipe.

Still another embodiment of the present disclosure provides an automotive system including an internal combustion engine provided with an exhaust pipe and means for determining a value of a mass flow rate of exhaust gasses flowing into the exhaust pipe, means for sampling a signal yielded by a temperature sensor located in a first point of the exhaust pipe, means for applying the signal as input to a first computational module that yields a corresponding first output signal, and means for calculating a value of the temperature of the exhaust gasses flowing in the first point of the exhaust pipe on the basis of a value of the first output signal, wherein the first computational module has the following transfer function (in frequency domain):

F*(s)=(1+τ_{RT}·s)·F(s)

wherein F(s) is the signal yielded by the temperature sensor, F*(s) is the first output signal and τ_{RT} is a coefficient determined as a function of the measured value of the mass flow rate of exhaust gasses. This solution achieves essentially the same effects of the method described above, in particular that of providing a reliable prediction of the real exhaust gas temperature without delay.

According to an aspect of the apparatus, the first computational module may implement the following equation (in time domain):

f*(t)=f(t)+τ_{RT}·f′(t)

wherein f(t) is a value of the signal sampled at a time t, f*(t) is a value of the first output signal at the time t, and f′(t) is a value of a derivative of the signal at the time t. This aspect provides an effective solution for allowing the first computational module to respond according to the required transfer function, while processing the sensor signal in time domain.

According to another aspect, the apparatus may include means for calculating the value f′(t) of the derivative of the signal with a finite difference equation. The use of a difference equation allows a reliable approximation of the derivative of the signal.

In particular, the means for calculating the value f′(t) of the derivative of the signal may use with the following finite difference equation:

$${f}^{′} ( t ) = \frac{1}{T} \cdot {\sum }_{k = 0}^{n} {C}_{k} \cdot f ( t - kT )$$

wherein T is a sampling period of the signal, f(t−kT) is a value of the signal sampled at the time t−kT, Cₖ is a predetermine coefficient and n is a predetermined positive real number. This difference equation is the equation of a “backward finite difference” which has the effect of providing reliable results with a limited computational effort.

By way of example, the sampling period T may be equal to 0.1 seconds, the number n may be equal to 3, the coefficient C₀ may be equal to 11/6, the coefficient C₁ may be equal to 3, the coefficient C₂ may be equal to 3/2 and the coefficient C₃ may be equal to ⅓. In this way, the “backward finite difference equation” has a 3rd order accuracy (n=3), thereby guaranteeing an efficient computational structure and noise suppression.

According to a different aspect, the apparatus may include means for applying the first output signal to a second computational module that yields a corresponding second output signal, and means for calculating the value of the temperature of the exhaust gasses flowing in the first point of the exhaust pipe on the basis of a value of the second output signal, wherein the second computational module has the following transfer function (in frequency domain):

$${F}^{**} ( s ) = \frac{1}{1 + {τ}_{TC} \cdot s} \cdot {F}^{*} ( s )$$

wherein F**(s) is the second output signal and τ_{TC} is a coefficient determined as a function of the measured value of the mass flow rate of exhaust gasses. As a matter of fact, the second computational module is a first-order filter with time constant τ_{TC}. This filter is useful for preventing too fast responses during transients and thus for reducing noises of the first output signal.

According to an aspect of the apparatus, the second computational module may implement the following equation (in time domain):

$${f}^{**} ( t ) = K \cdot ( 1 - {e}^{\frac{- t}{{τ}_{TC}}} ) \cdot {f}^{*} ( t )$$

wherein f*(t) is a value of the first output signal at a time t, f**(t) is a value of the second output signal at the time t and K is a coefficient. This aspect provides an effective solution for allowing the second computational module to respond according to the required transfer function, while processing the signal in time domain.

According to another aspect of the apparatus, the second computational module may implement the following equation:

f**(t)=f*(t)·K_{TC}+f**(t−T)·(1−K_{TC})

wherein f*(t) is a value of the first output signal at a time t, f**(t) is a value of the second output signal at the time t, K_{TC} is a coefficient determined as a function of the measured value of the flow rate of exhaust gasses, and T is a sampling period of the signal. This particular solution has the effect of providing reliable results with a limited computational effort.

According to a different aspect, the apparatus may include means for estimating a value of a temperature of the exhaust gasses flowing in a second different point of the exhaust pipe on the basis of the calculated value of the temperature of the exhaust gasses in the first point. Taking advantage of the accelerated response of the temperature sensor located in the first point of the exhaust pipe, this aspect allows a reliable and efficient estimation of the exhaust gas temperature also in another point of the exhaust pipe, without the need of additional temperature sensors.

In particular, the means for calculating the temperature of the exhaust gasses flowing in the second point of the exhaust pipe may use the following equation:

$${T}_{1} \cdot {\dot{m}}_{g} \cdot {c}_{{p}_{g}} + {T}_{u} \cdot {\dot{m}}_{u} \cdot {c}_{{p}_{u}} + {T}_{2} \cdot ( {\dot{m}}_{g} \cdot {c}_{{p}_{g}} + {\dot{m}}_{u} \cdot {c}_{{p}_{u}} ) - ( {m}_{u} + {m}_{g} ) \cdot {c}_{{p}_{m}} \cdot \frac{{dT}_{m}}{dt} - {\dot{Q}}_{mw} - {\dot{m}}_{u} \cdot {k}_{vap} = 0$$

wherein T₁ is a value of the temperature of the exhaust gasses flowing in a first point of the exhaust pipe, \dot{m}_{g} is the value of a mass flow rate of exhaust gasses flowing in the exhaust pipe, cₚ_{_{g}} is a specific heat capacity of the exhaust gasses, Tᵤ is a temperature value of a fluid injected by an injector located between the first and the second point of the exhaust pipe, \dot{m}ᵤ is a value of a mass flow rate of the injected fluid, cₚ_{ᵤ} is a specific heat capacity of the injected fluid, T₂ is the value of the temperature of the exhaust gasses flowing in the second point of the exhaust pipe, mᵤ is a value of a mass of the injected fluid in the exhaust pipe, m_{g} is a value of a mass of exhaust gasses in the exhaust pipe, cₚ_{ₘ} is a specific heat capacity of a mixture of exhaust gasses and injected fluid in the exhaust pipe, is a mean value of the temperature of the mixture of exhaust gasses and injected fluid, \dot{Q}_{mw} is a value of a thermal flux between the exhaust pipe and the mixture of exhaust gasses and injected fluid, and kᵥₐₚ is a coefficient representative of an energy spent for mixing and vaporizing the injected fluid. This aspect provides an effective thermal model of the portion of the exhaust pipe upstream around the fluid injector, which takes into account all the major thermal effects that happen in such portion of the exhaust pipe, including the energy consumed to mix and vaporize the injected fluid within the exhaust gasses (by the term −\dot{m}ᵤ·kᵥₐₚ of the above-indicated equation), thereby yielding a reliable estimation of the exhaust gas temperature along such portion of the exhaust pipe.

### BRIEF DESCRIPTION OF THE DRAWINGS

The present disclosure will hereinafter be described in conjunction with the following drawing figures, wherein like numerals denote like elements.

FIG. 1 schematically shows an automotive system according to an embodiment of the solution;

FIG. 2 is the section A-A of an internal combustion engine belonging to the automotive system of FIG. 1;

FIG. 3 is a schematic representation of an aftertreatment system of the automotive system of FIG. 1; and

FIG. 4 is a flowchart representing a method of monitoring the temperature of the gas stream in the aftertreatment system of FIG. 3.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

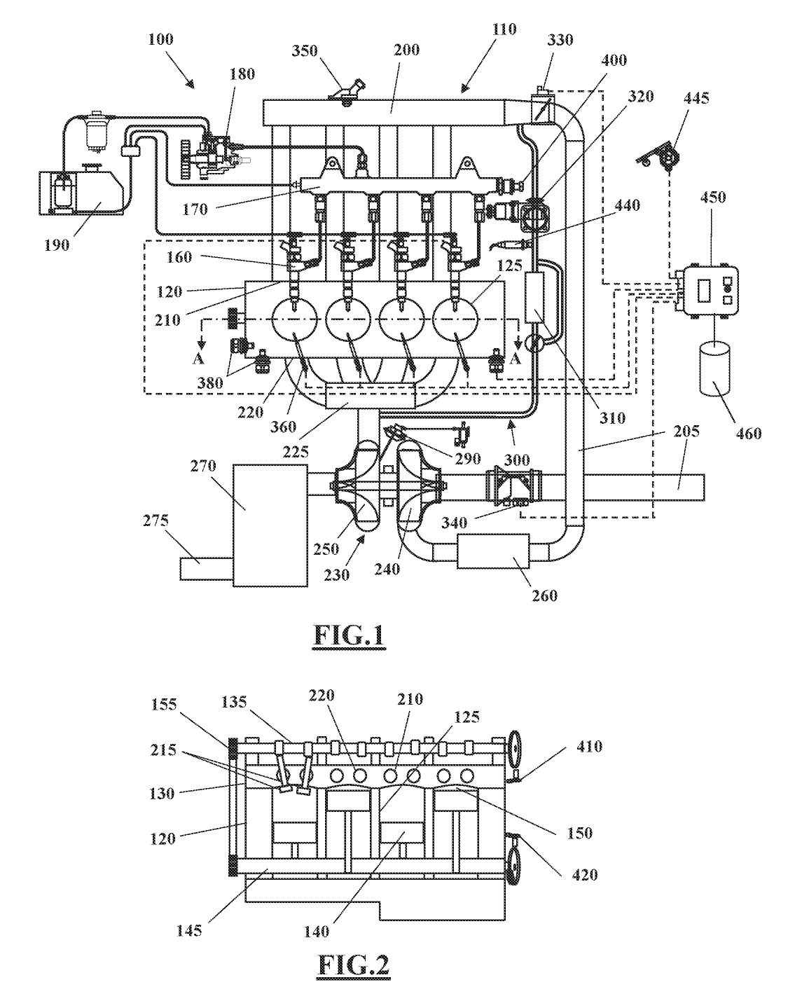

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increases the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gasses to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gasses from an exhaust manifold 225 that directs exhaust gasses from the exhaust ports 220 and through a series of vanes prior to expansion through the turbine 250. This example shows a variable geometry turbine (VGT) with a VGT actuator 290 arranged to move the vanes to alter the flow of the exhaust gasses through the turbine 250. In other embodiments, the turbocharger 230 may be fixed geometry and/or include a waste gate.

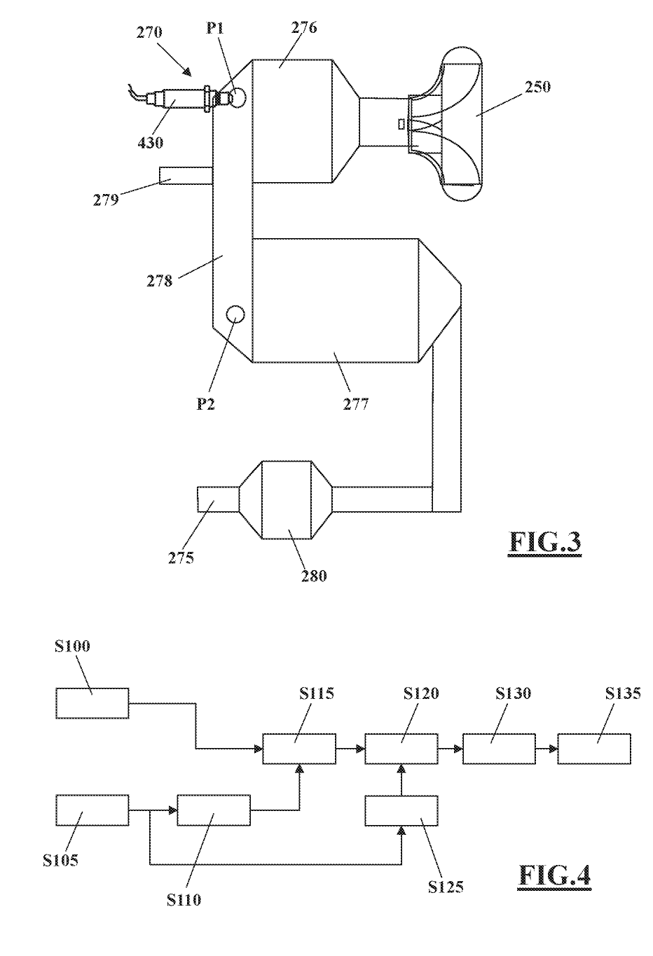

The exhaust gasses exit the turbine 250 and are directed into an exhaust system 270. The exhaust system 270 may include an exhaust pipe 275 having one or more exhaust aftertreatment devices. The aftertreatment devices may be any device configured to change the composition of the exhaust gasses. As shown in FIG. 3, the aftertreatment devices may include a Diesel Oxidization Catalyst (DOC) 276, which is disposed immediately downstream of the turbine 250 to promote the oxidization of hydrocarbons and carbon monoxides into carbon dioxides and water. The aftertreatment devices may also include a Selective Catalytic Reduction (SCR) brick 277, which is disposed downstream of the DOC 276 to promote the conversion of nitrogen oxides (NOₓ) into diatomic nitrogen and water. In some embodiments, the SCR brick 277 may be embodied as a diesel particulate filter (DPF) coated with a selective catalytic reduction (SCR) catalyst, so that it is also able to trap the particulate matter or soot that may be present in the stream of the exhaust gasses. In this latter case, the SCR brick 277 is usually referred as to Selective Catalytic Reduction on Filter (SCRF) and serves the purposes of both a DPF and an SCR. The outlet of the DOC 276 and the inlet of the SCR brick 277 are fluidly connected by a conduit 278, also referred as to transfer tube, which is a portion of the exhaust pipe 275.

An injector 279 may be disposed in the conduit 278 for injecting a Diesel Exhaust Fluid (DEF), typically urea or ammonia, into the stream of exhaust gasses. The DEF vaporizes, mixes with the exhaust gasses and is adsorbed into the SCR brick 277 to serve as a reducing agent. To improve the mixing of the DEF, a mixer (not shown) may be located in the conduit 278, between the DEF injector 279 and the inlet of the SCR brick 277. The aftertreatment system 270 may further include an Ammonia Slip Catalyst (ASC) 280, which is disposed downstream of the SCR brick 277.

Some embodiments may further include an exhaust gas recirculation (EGR) system 300, as shown in FIG. 1, which is coupled between the exhaust manifold 225 and the intake manifold 200. The EGR system 300 may include an EGR cooler 310 to reduce the temperature of the exhaust gasses in the EGR system 300. An EGR valve 320 regulates a flow of exhaust gasses in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system 460, and send and receive signals to/from the interface bus. The memory system 460 may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The program stored in the memory system 460 is transmitted from outside via a cable or in a wireless fashion. Outside the automotive system 100 it is normally visible as a computer program product, which is also called computer readable medium or machine readable medium in the art, and which should be understood to be a computer program code residing on a carrier, the carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing the computer program code is impressed on the transitory electromagnetic signal. Such signals are e.g. made use of when transmitting computer program code in a wireless fashion via a Wi-Fi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

In order to properly manage the operation of the internal combustion engine 110 and/or the aftertreatment system 270, the ECU 450 may need to monitor the temperature of the exhaust gas stream flowing in a point P1 of the connecting conduit 278, which is located at the outlet of the DOC 276 upstream of the DEF injector 279, and also the temperature of the mixture of exhaust gasses and DEF flowing in a point P2 of the connecting conduit 278, which is located at the inlet of the SCR brick 277 downstream of the DEF injector 279.

To determine the exhaust gas temperature at the outlet of the DOC 276, the ECU 450 may be in communication with a temperature sensor 430, which is disposed in the point P1 of the connecting conduit 278 to generate and send to the ECU 450 an electric signal which is indicative of the exhaust gas temperature in that point.

In order to implement a simple and cost effective solution, the temperature sensor 430 may be a thermistor, whose electrical resistance is dependent on the temperature of the exhaust gasses. As a consequence, when supplied with a constant current, the temperature sensor 430 yields a voltage signal whose amplitude is proportional to its resistance and thus to the exhaust gas temperature.

However, during transients, the dynamic response of the temperature sensor 430 substantially corresponds to the response of a first order dynamic system (actually of a first-order filter). In other words, the transfer function (in frequency domain) of the temperature sensor 430 may be defined by the following equation:

$$F ( s ) = \frac{1}{1 + {τ}_{RT} \cdot s} X ( s )$$

wherein X(s) is the input of the temperature sensor 430 in frequency domain (in this case the real temperature of the exhaust gasses in P1), F(s) is the output of the temperature sensor 430 in frequency domain (in this case the amplitude of the voltage signal) and τ_{RT} is the time constant of the temperature sensor 430 (in this case a thermistor), which depends on the mass flow rate of exhaust gasses that flow through the temperature sensor 430.

As a consequence, the dynamic response of the temperature sensor 430 is inherently affected by a so-called “response delay”, which is the time necessary for the temperature sensor 430 to change its output in response to a change in the real temperature of the exhaust gasses.

To compensate for this “delay”, the ECU 450 may be configured to execute the strategy represented in the flowchart of FIG. 4. The ECU 450 may be configured to sample (block S100) the signal generated by the temperature sensor (430), which will be hereinafter referred as to “rough signal”, and to determine (block S105) a current value \dot{m}_{g} of the mass flow rate of exhaust gasses flowing through the exhaust pipe 275, in particular the mass flow rate of exhaust gasses flowing in the point P1 of the connecting conduit 278.

The mass flow rate \dot{m}_{g} of the exhaust gasses may be measured by a dedicated sensor or estimated on the basis of other parameters, such as for example the air mass flow rate (as measured by the mass airflow sensor 340) and/or the engine speed (i.e. the rotational speed of the crankshaft 145) and/or engine load and/or the recirculated exhaust gas quantity.

On the basis of this value \dot{m}_{g} of the mass flow rate, the ECU 450 may be configured to determine (block S110) a current value of the time constant τ_{RT} of the temperature sensor 430. For example, the ECU 450 may use the current value \dot{m}_{g} of the mass flow rate as input of a calibration map or calculation module that yields as output a corresponding value of the time constant τ_{RT}. Such calibration map or module may be determined by an experimental activity.

Knowing the current value time constant τ_{RT} of the time constant, the ECU 450 may be configured to apply the rough signal F(s) as input to a first computational module (block S115) having the following transfer function (in frequency domain):

F*(s)=(1+τ_{RT}·s)·F(s)

wherein F*(s) is the output of the first computational module.

As a matter of fact, the transfer function of the first computational module is substantially the inverse of the transfer function of the temperature sensor 430, so that the output of such a computational module represents a reliable prediction of the real exhaust gas temperature without delay.

In order to obtain the required transfer function, the first computational module may be configured to perform calculations in time domain and according to the following equation:

f*(t)=f(t)+τ_{RT}·f′(t)

wherein f(t) is the value of the rough signal (in time domain) sampled at a time t, f*(t) is the corresponding value of the output signal (in time domain) yielded by the first computational module at the time t, and f′(t) is a value of a derivative of the rough signal (in time domain) at the time t.

In particular, the calculation of the value f′(t) of the derivative of the signal may be performed by the ECU 450 using a “backward finite difference” according to the following formula:

$${f}^{′} ( t ) = \frac{1}{T} \cdot {\sum }_{k = 0}^{n} {C}_{k} \cdot f ( t - kT )$$

wherein T is the sampling period of the signal, f(t−kT) is the value of the signal sampled at the time t−kT, Cₖ is a coefficient and n is a positive real number that represents the order of the finite difference.

By way of example, the finite difference may have a 3rd-order accuracy (n=3) according to the following equation:

$${f}^{′} ( t ) = \frac{11 / 6 f ( {x}_{i} ) - 3 f ( {x}_{i} - 0.1 ) + 3 / 2 f ( {x}_{i} - 0.2 ) - 1 / 3 f ( {x}_{i} - 0.3 )}{0.1}$$

wherein the sampling period T is equal to 0.1 seconds and the coefficients are chosen as follows: C₀=11/6, C₁=3, C₂=3/2 and C₃=⅓. This specific solution guarantees an efficient computational structure and noise suppression. However, it is not excluded that other embodiments may chose different implementations or parameters.

In order to reduce the noises that could affect the output signal of the first calculation module, the ECU 450 may be further configured to apply such output signal to a second computational module (block S120) having the following transfer function (in frequency domain):

$${F}^{**} ( s ) = \frac{1}{1 + {τ}_{TC} \cdot s} \cdot {F}^{*} ( s )$$

wherein F**(s) is the output of the second computational module (in frequency domain) and τ_{TC} is a predetermined coefficient. As a matter of fact, the second computational module is a first-order filter and τ_{TC} is the time constant of such filter.

The current value of the time constant τ_{TC} may be predetermined (block S125) by the ECU 450 on the basis of the current value \dot{m}_{g} of the mass flow rate of the exhaust gasses. For example, the ECU 450 may use the current value \dot{m}_{g} of the mass flow rate as input of a calibration map or calculation module that yields as output a corresponding value of the time constant τ_{TC}. Such calibration map may be determined by an experimental activity. In particular, the values of the time constant τ_{TC} may be calibrated so as to correspond to the values of the time constant that a “fast-response” temperature sensor, such as for example a thermocouple, would have if used in lieu of the temperature sensor 430.

In order to obtain the required transfer function, the second computational module may be configured to perform calculations in time domain according to the following equation:

$${f}^{**} ( t ) = K \cdot ( 1 - {e}^{\frac{- t}{{τ}_{TC}}} ) \cdot {f}^{*} ( t )$$

wherein f*(t) is the value of the output signal (in time domain) yielded by the first computational module at a time t, f**(t) is the value of the output signal (in time domain) yielded by the second calculation module at the time t and K is a predetermined coefficient (usually referred as to gain of the filter).

However, in order to reduce the computational effort, some embodiments may provide for the second computational to calculate the value f**(t) of the output signal according to the following equation in the time domain:

f**(t)=f*(t)·K_{TC}+f**(t−T)·(1−K_{TC})

wherein K_{TC} is a coefficient that may be predetermined as a function of the measured value \dot{m}_{g} of the flow rate of exhaust gasses, and T is the sampling period of the rough signal.

It should be noted that in some embodiments the first and the second calculation modules may be merged in a single calculation module or, in other words, the second calculation module may be included in the first calculation module.

In those cases, the transfer function (in frequency domain) of the single calculation module will be the following:

$${F}^{**} ( s ) = \frac{1 + {τ}_{RT} \cdot s}{1 + {τ}_{TC} \cdot s} \cdot F ( s )$$

and the equations in the time domain of the first and second module will be combined accordingly.

In any case, the value f**(t) of the output signal yielded by the second computational module may be finally used by the ECU 450 to calculate (block S130) the value of the exhaust gas temperature in the point where the temperature sensor 430 is actually located, in this case in the point P1 at the outlet of the DOC 276. The calculation of this temperature value may be performed by a mathematical model of the temperature sensor 430, according to conventional strategies.

Once the value of the exhaust gas temperature in P1 has been calculated, the ECU 450 may be configured to estimate (block S135) a value of the exhaust gas temperature in the point P2 of the connecting conduit 278, in this case at the inlet of the SCR brick 277, downstream of the DEF injector 279 and the mixer (if present).

This temperature estimation may be performed by the ECU 450 using a physical model that represents the thermal interactions inside the conduit 278 that connects the DOC 276 to the SCR brick 277. This physical model may be defined by the following six equations:

$$\{ \begin{matrix}\begin{matrix}{T}_{1} \cdot {\dot{m}}_{g} \cdot {c}_{{p}_{g}} + {T}_{u} \cdot {\dot{m}}_{u} \cdot {c}_{{p}_{u}} + {T}_{2} \cdot ( {\dot{m}}_{g} \cdot {c}_{{p}_{g}} + {\dot{m}}_{u} \cdot {c}_{{p}_{u}} ) - \\ ( {m}_{u} + {m}_{g} ) \cdot {c}_{{p}_{m}} \cdot \frac{{dT}_{m}}{dt} - {\dot{Q}}_{mw} - {\dot{m}}_{u} \cdot {k}_{vap} = 0\end{matrix} \\ {\dot{Q}}_{mw} = {h}_{mw} \cdot {A}_{1} \cdot ( {T}_{m} - {T}_{w} ) \\ {h}_{mw} = \frac{{h}_{gw} \cdot {\dot{m}}_{g} + {h}_{uw} \cdot {\dot{m}}_{u}}{{\dot{m}}_{g} + {\dot{m}}_{u}} \\ \frac{{dT}_{w}}{dt} = \frac{{\dot{Q}}_{mw} - {\dot{Q}}_{wa}}{{m}_{w} \cdot {c}_{{p}_{w}}} \\ {\dot{Q}}_{wa} = {h}_{wa} \cdot {A}_{2} \cdot ( {T}_{w} - {T}_{a} ) \\ {T}_{m} = \frac{1}{2} \cdot ( {T}_{2} + \frac{{T}_{1} \cdot {\dot{m}}_{g} + {T}_{u} \cdot {\dot{m}}_{u}}{{\dot{m}}_{g} + {\dot{m}}_{u}} )\end{matrix}$$

The quantity T₁ is the value of the temperature of the gas stream (exhaust gas only) that flows at the outlet of the diesel oxidation catalyst 276, namely in the point P1 of the connecting conduit 278.

The quantity \dot{m}_{g} is the value of a mass flow rate of exhaust gasses that flow in the connecting conduit 278. The quantity \dot{m}_{g} is an input of the physical system and, as already explained, it may be determined by the ECU 450 on the basis of the engine speed, engine load and possibly on the basis of other operating parameters of the engine 110, such as the recirculated exhaust gas quantity.

The quantity cₚ_{_{g}} is a specific heat capacity of the exhaust gasses. The quantity cₚ_{_{g}} is a constant which may be predetermined and memorized in a dedicated map stored in the memory system 460.

The quantity Tᵤ is a value of the temperature of the diesel exhaust fluid that is injected by the DEF injector 279. The quantity Tᵤ is an input of the physical system and may be measured by a dedicated sensor disposed in a DEF tank (not shown) that provides the diesel exhaust fluid to the DEF injector 279.

The quantity \dot{m}ᵤ is a value of a mass flow rate of the diesel exhaust fluid that is injected by the DEF injector 279. The quantity \dot{m}ᵤ is another input of the physical system and may be determined by the ECU 450 according to the strategies that are used to operate the DEF injector 279.

The quantity cₚ_{ᵤ} is a specific heat capacity of the diesel exhaust fluid. The quantity cₚ_{ᵤ} is a constant which may be predetermined and memorized in a dedicated map stored in the memory system 460.

The quantity T₂ is the value of the temperature of the gas stream (mix of exhaust gas and DEF) that flow at the inlet of the SCR brick 277, namely in the point P2 of the connecting conduit 278.

The quantity mᵤ is a value of a mass of diesel exhaust fluid in the connecting conduit 278. The quantity mᵤ is an input of the physical system that may be determined by the ECU 450 on the basis of the geometry of the conduit 278 and of the operation of the DEF injector 279.

The quantity m_{g} is a value of a mass of exhaust gasses in the connecting conduit 278. The quantity m_{g} is another input of the system that may be determined by the ECU 450 on the basis of the geometry of the conduit 278 and the operation of the internal combustion engine 110.

The quantity cₚ_{ₘ} is a specific heat capacity of a mixture of exhaust gasses and diesel exhaust fluid in the conduit. The quantity cₚ_{ₘ} is a constant that may be predetermined and memorized in a dedicated map stored in the memory system 460.

The quantity Tₘ is a mean value of the temperature of the mixture of exhaust gasses and diesel exhaust fluid inside the connecting conduit 278.

The quantity kᵥₐₚ is a coefficient that represents the energy consumed to mix and vaporize a unitary quantity of DEF which is injected in the connecting conduit 278 by the DEF injector 279. The coefficient kᵥₐₚ may be a calibration parameter which is determined with an experimental activity and then stored in the memory system.

The quantity \dot{Q}_{mw} is a value of a thermal flux between the connecting conduit 278, namely the wall of the connecting conduit 278, and the mixture of exhaust gasses and diesel exhaust fluid flowing inside.

The quantity h_{mw} is a heat transfer coefficient between the connecting conduit 278, namely the wall of the connecting conduit 278, and the mixture of exhaust gasses and diesel exhaust fluid flowing inside.

The quantity A₁ is a value of a whole inner surface of the connecting conduit 278. The quantity A₁ is a constant depending only on the geometry of the conduit 278 and may be memorized in the memory system 460.

The quantity T_{w} is a value of the temperature of the connecting conduit 278, namely of the wall of the conduit 278. The quantity T_{w} is an input of the system which may be estimated or measured by the ECU 450 by a dedicated sensor.

The quantity h_{gw} is a heat transfer coefficient between the connecting conduit 278, namely the wall of the connecting conduit 278, and the exhaust gasses in the conduit 278.

The quantity h_{uw} is a heat transfer coefficient between the connecting conduit 278, namely the wall of the connecting conduit 278, and the diesel exhaust fluid in the conduit 278.

The quantity \dot{Q}_{wa} is a value of a thermal flux between the connecting conduit 278, namely the wall of the connecting conduit 278, and the external environment.

The quantity m_{w} is a value of a mass of the connecting conduit 278. The quantity m_{w} is a constant that depends only on the geometry of the conduit 278 and that may be stored in the memory system 460.

The quantity cₚ_{_{w}} is a specific heat capacity of the connecting conduit 278. The quantity cₚ_{_{w}} is a constant which may be predetermined and memorized in a dedicated map stored in the memory system 460.

The quantity h_{wa} is a heat transfer coefficient between the connecting conduit 278, namely the wall of the conduit 278, and the external environment. The quantity h_{wa} is an input of the system that can be determined by the ECU 450.

The quantity A₂ is a value of a whole outer surface of the connecting conduit 278. The quantity A₂ is a constant depending only on the geometry of the conduit 278 and may be memorized in the memory system 460.

The quantity Tₐ is a value of the external environment temperature. The quantity Tₐ is an input of the system which may be measured by the ECU 450 by a dedicated sensor.

As a matter of fact, the physical model is defined by six equations having the following unknown quantities: T₁, T₂, Tₘ, \dot{Q}_{mw}, h_{mw}, h_{gw}, h_{uw}, \dot{Q}_{wa}. As a consequence, measuring T₁ as explained above and solving the system of the aforesaid equations, the ECU 450 is able to calculate the value T₂ of the temperature of the mixture of exhaust gas and DEF flowing in the point P2 of the connecting conduit 278.

It should be noted that the above-described strategy could be reversed. In other words, the temperature sensor 430 may be alternatively disposed at the inlet of the SCR brick 277 to measure the temperature of the mixture of exhaust gas and DEF in the point P2 of the connecting conduit 278, and the ECU 450 may be configured to use that measured temperature to estimate the temperature of the exhaust gas at the outlet of the DOC 276, namely in the point P1 of the connecting conduit 278, by solving the very same system of equations described above.

The temperature values T₁ and/or T₂ may then be used by the ECU 450 to manage the operation of the internal combustion engine 110 and/or of the aftertreatment system 270. By way of example, they may be used to control the quantity of fuel injected by the fuel injectors 160 into the combustion chambers 150, in order to meet a desired value of the exhaust gas temperature along the exhaust pipe 275.

It should be observed that the temperature estimation approach explained above can be used to calculate the exhaust temperature upstream or downstream of any fluid injector that can be located in the exhaust pipe.

For example, some embodiments may include a hydrocarbon (HC) injector (not shown) located in the exhaust pipe 275 upstream of the DOC 276. In these embodiments, the above-mentioned approach may be used to calculate the temperature of the exhaust gas downstream of a hydrocarbon (HC) injector starting from an exhaust gas temperature measured upstream of such HC injector, or vice versa. In particular, the same equations reported above can be used, simply replacing the parameters characteristic of the DEF with corresponding parameters characteristic of the HC.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method of measuring exhaust gas temperatures in an exhaust pipe of an internal combustion engine comprising:
determining a value of a mass flow rate of exhaust gasses flowing into the exhaust pipe;
sampling a signal yielded by a temperature sensor located in a first point of the exhaust pipe;
applying the signal as input to a first computational module that yields a corresponding first output signal, wherein the first computational module has the following transfer function:
F*(s)=(1+τ_{RT}·s)·F(s)
calculating a value of the temperature of the exhaust gasses flowing in the first point of the exhaust pipe on the basis of the first output signal; and
wherein F(s) is the signal yielded by the temperature sensor, F*(s) is the first output signal and τ_{RT} is a coefficient determined as a function of the measured value of the mass flow rate of exhaust gasses.

2. The method according to claim 1, wherein the first computational module implements the following equation:
f*(t)=f(t)+τ_{RT}·f′(t)
wherein f(t) is a value of the signal sampled at a time t, f*(t) is a value of the first output signal at the time t, and f′(t) is a value of a derivative of the signal at the time t.

3. The method according to claim 2, further comprising calculating the value f′(t) of the derivative of the signal with a finite difference equation.

4. The method according to claim 3, wherein the calculation of the value f′(t) of the derivative of the signal is performed with the following finite difference equation:
$${f}^{′} ( t ) = \frac{1}{T} \cdot {\sum }_{k = 0}^{n} {C}_{k} \cdot f ( t - kT )$$
wherein T is a sampling period of the signal, f(t−kT) is a value of the signal sampled at the time t−kT, Cₖ is a predetermined coefficient and n is a predetermined positive real number.

5. The method according to claim 4, wherein T is equal to 0.1 seconds, n is equal to 3, C₀ is equal to 11/6, C₁ is equal to 3, C₂ is equal to 3/2 and C₃ is equal to ⅓.

6. The method according to claim 1, further comprising:
applying the first output signal to a second computational module that yields a corresponding second output signal, wherein the second computational module has the following transfer function:
$${F}^{**} ( s ) = \frac{1}{1 + {τ}_{TC} \cdot s} \cdot {F}^{*} ( s )$$
calculating the value of the temperature of the exhaust gasses flowing in the first point of the exhaust pipe on the basis of a value of the second output signal;
wherein F**(s) is the second output signal and τ_{TC} is a coefficient determined as a function of the measured value of the mass flow rate of exhaust gasses,

7. The method according to claim 6, wherein the second computational module implements the following equation:
$${f}^{**} ( t ) = K \cdot ( 1 - {e}^{\frac{- t}{{τ}_{TC}}} ) \cdot {f}^{*} ( t )$$
wherein f*(t) is a value of the first output signal at a time t, f**(t) is a value of the second output signal at the time t and K is a coefficient.

8. The method according to claim 6, wherein the second computational module implements the following equation:
f**(t)=f*(t)·K_{TC}+f**(t−T)·(1−K_{TC})
wherein f*(t) is a value of the first output signal at a time t, f**(t) is a value of the second output signal at the time t, K_{TC} is a coefficient determined as a function of the measured value of the flow rate of exhaust gasses, and T is a sampling period of the signal.

9. The method according to claim 1, further comprising estimating a value of a temperature of the exhaust gasses flowing in a second different point (P2) of the exhaust pipe (275) on the basis of the calculated value of the temperature of the exhaust gasses in the first point (P1).

10. The method according to claim 9, wherein the value of the temperature of the exhaust gasses flowing in the second point of the exhaust pipe is calculated with the following equation:
$${T}_{1} \cdot {\dot{m}}_{g} \cdot {c}_{{p}_{g}} + {T}_{u} \cdot {\dot{m}}_{u} \cdot {c}_{{p}_{u}} + {T}_{2} \cdot ( {\dot{m}}_{g} \cdot {c}_{{p}_{g}} + {\dot{m}}_{u} \cdot {c}_{{p}_{u}} ) - ( {m}_{u} + {m}_{g} ) \cdot {c}_{{p}_{m}} \cdot \frac{{dT}_{m}}{dt} - {\dot{Q}}_{mw} - {\dot{m}}_{u} \cdot {k}_{vap} = 0$$
wherein T₁ is a value of the temperature of the exhaust gasses flowing in a first point of the exhaust pipe, \dot{m}_{g} is the value of a mass flow rate of exhaust gasses flowing in the exhaust pipe (278), cₚ_{_{g}} is a specific heat capacity of the exhaust gasses, Tᵤ is a temperature value of a fluid injected by an injector (279) located between the first and the second point of the exhaust pipe, \dot{m}ᵤ is a value of a mass flow rate of the injected fluid, cₚ_{ᵤ} is a specific heat capacity of the injected fluid, T₂ is the value of the temperature of the exhaust gasses flowing in the second point of the exhaust pipe, mᵤ is a value of a mass of the injected fluid in the exhaust pipe (278), m_{g} is a value of a mass of exhaust gasses in the exhaust pipe (278), cₚ_{ₘ} is a specific heat capacity of a mixture of exhaust gasses and injected fluid in the exhaust pipe (278), Tₘ is a mean value of the temperature of the mixture of exhaust gasses and injected fluid, \dot{Q}_{mw} is a value of a thermal flux between the exhaust pipe (278) and the mixture of exhaust gasses and injected fluid, and kᵥₐₚ is a coefficient representative of an energy spent for mixing and vaporizing the injected fluid and kᵥₐₚ is a coefficient representative of an energy spent for mixing and vaporizing the injected fluid.

11. A non-transitory computer readable medium comprising a computer program for measuring exhaust gas temperatures in an exhaust pipe of an internal combustion engine, the computer program having a program code, which when run on a computer, is configured to:
determine a value of a mass flow rate of exhaust gasses flowing into the exhaust pipe;
sample a signal yielded by a temperature sensor located in a first point of the exhaust pipe;
apply the signal as input to a first computational module that yields a corresponding first output signal, wherein the first computational module has the following transfer function:
F*(s)=(1+τ_{RT}·s)·F(s)
calculate a value of the temperature of the exhaust gasses flowing in the first point (P1) of the exhaust pipe (275) on the basis of a value of the first output signal;
wherein F(s) is the signal yielded by the temperature sensor, F*(s) is the first output signal and τ_{RT} is a coefficient determined as a function of the measured value of the mass flow rate of exhaust gasses.

12. An internal combustion engine comprising an exhaust pipe having a temperature sensor located in a first point of the exhaust pipe and an electronic control unit configured to:
determine a value of a mass flow rate of exhaust gasses flowing into the exhaust pipe;
sample a signal yielded by the temperature sensor;
apply the signal as input to a first computational module that yields a corresponding first output signal, wherein the first computational module has the following transfer function:
F*(s)=(1+τ_{RT}·s)·F(s)
calculate a value of the temperature of the exhaust gasses flowing in the first point (P1) of the exhaust pipe (275) on the basis of a value of the first output signal;
wherein F(s) is the signal yielded by the temperature sensor, F*(s) is the first output signal and τ_{RT} is a coefficient determined as a function of the measured value of the mass flow rate of exhaust gasses.
